(19) United States
(12) Patent Application Publication
(10) Pub. No.: US 2015/0253601 A1
(43) Pub. Date: Sep. 10, 2015

(54) LIQUID CRYSTAL DISPLAY PANEL AND METHOD OF MANUFACTURING THE SAME

(71) Applicant: Samsung Display Co., Ltd., Yongin-City (KR)

(72) Inventors: Pil-Soon Hong, Yongin-City (KR); Gwui-Hyun Park, Yongin-City (KR); Jin-Ho Ju, Yongin-City (KR)

(21) Appl. No.: 14/507,745

(22) Filed: Oct. 6, 2014

(30) Foreign Application Priority Data
Mar. 6, 2014 (KR) 10-2014-0026806

(51) Int. Cl. G02F 1/1341; G02F 1/1368; G02F 1/1335; G02F 1/1333; G02F 1/1343

(52) U.S. Cl. CPC G02F 1/1341; G02F 1/133345; G02F 1/1343; G02F 1/133514; G02F 1/133512; G02F 1/1368

(57) ABSTRACT

A method of manufacturing a liquid crystal display panel. The method includes: preparing a substrate; forming a sacrificial pattern including a negative photoresist material on the substrate; forming a loop portion to cover top and side surfaces of the sacrificial pattern and to expose one side surface of the sacrificial pattern; forming a cavity defined as a predetermined region in the loop portion by performing a strip process on the exposed side surface of the sacrificial pattern by using (utilizing) a strip solution and removing the sacrificial pattern; forming a liquid crystal layer by injecting liquid crystal in the cavity; and forming a blocking member to cover a surface of the cavity into which the liquid crystal is injected.

### CROSS-REFERENCE TO RELATED APPLICATION

This application claims priority to and the benefit of Korean Patent Application No. 10-2014-0026806, filed on Mar. 6, 2014, in the Korean Intellectual Property Office, the disclosure of which is incorporated herein in its entirety by reference.

### BACKGROUND

1. Field

One or more embodiments of the present invention relate to a liquid crystal display panel and a method of manufacturing the same.

2. Description of the Related Art

Conventional display panels have been recently replaced with portable thin flat display panels. Among the flat display panels, liquid crystal display panels are attracting public attention because they have low power consumption and generate little electromagnetic waves.

In brief, a liquid crystal display panel is manufactured by injecting a liquid crystal layer between two members. If an electric field is generated around the liquid crystal layer, the molecular arrangement of the liquid crystal layer changes. A state of light that passes through the liquid crystal layer, in particular, a phase difference in light caused by the liquid crystal layer, changes according to the change in the molecular arrangement.

Accordingly, desired images may be formed by controlling the arrangement of the liquid crystal layer.

In this regard, electrodes, particularly a pixel electrode and a common electrode, are formed around the liquid crystal layer to generate the electric field.

If voltage is applied to the pixel electrode and the common electrode, an electric field is generated between the pixel electrode and the common electrode. The electric field changes the molecular arrangement of the liquid crystal layer.

### SUMMARY

Aspects according to one or more embodiments of the present invention are directed toward a liquid crystal display panel and a method of manufacturing the same.

Additional aspects will be set forth in part in the description which follows and, in part, will be apparent from the description, or may be learned by practice of the presented embodiments.

According to an embodiment of the present invention, a method of manufacturing a liquid crystal display panel includes preparing a substrate; forming a sacrificial pattern including a negative photoresist material on the substrate; forming a loop portion to cover top and side surfaces of the sacrificial pattern and to expose one side surface of the sacrificial pattern; forming a cavity defined as a set or predetermined region in the loop portion by performing a strip process on the exposed side surface of the sacrificial pattern using (utilizing) a strip solution and removing the sacrificial pattern; forming a liquid crystal layer by injecting liquid crystal in (i.e., inside) the cavity; and forming a blocking member to cover an opening of the cavity into which the liquid crystal is injected.

The sacrificial pattern may include a first region and a second region sequentially arranged in a width direction of the sacrificial pattern, wherein a side surface of the first region makes an obtuse angle with the substrate, and a side surface of the second region makes an acute angle with the substrate.

The forming of the sacrificial pattern may include performing photolithography using (utilizing) a half-tone mask, wherein a region of the half-tone mask corresponding to the first region may transmit a smaller amount of light than a region of the half-tone mask corresponding to the second region.

The side surface of the sacrificial pattern exposed in the forming of the loop portion may be formed in the second region.

The forming of the sacrificial pattern may include forming the second region to have a greater thickness than the first region.

The cavity may correspond to the first region.

The loop portion may include an organic material.

The method may further include, before the forming of the cavity by performing the strip process and after the forming of the loop portion, forming an intermediate protective layer on the loop portion, wherein the intermediate protective layer is formed without a patterning process and does not cover the exposed side surface of the sacrificial pattern that is not covered by the loop portion.

The method may further include removing the intermediate protective layer after the forming of the cavity.

The method may further include, after the forming of the cavity and before the forming of the liquid crystal layer, forming a cover layer on the loop portion.

The method may further include, after the forming of the sacrificial pattern and before the forming of the loop portion, forming a common electrode and a passivation layer on the sacrificial pattern, wherein the common electrode and the passivation layer are formed not to cover the exposed side surface of the sacrificial pattern that is not covered by the loop portion.

The method may further include, after the forming of the cavity and before the forming of the liquid crystal layer, removing regions of the third passivation layer and the common electrode not corresponding to the cavity.

The method may further include, after the preparing of the substrate and before the forming of the sacrificial pattern, forming a base structure including one or more wirings between the substrate and the sacrificial pattern.

The base structure may include at least one thin film transistor including an active layer, a gate electrode, a source electrode, and a drain electrode; and a pixel electrode electrically coupled (e.g., electrically connected) with the at least one thin film transistor.

The liquid crystal display panel may include a color filter and a black matrix between the at least one thin film transistor and the pixel electrode.

The base structure may include a common electrode on an upper portion of the pixel electrode; and an intermediate insulating layer between the pixel electrode and the common electrode.

The forming of the sacrificial pattern may include forming a plurality of sacrificial patterns spaced apart from each other, and the loop portion may be between the plurality of sacrificial patterns.

The forming of the cavity may include forming a plurality of cavities spaced apart from each other and corresponding to the plurality of sacrificial patterns.

According to another embodiment of the present invention, a liquid crystal display panel is manufactured using (utilizing) the method.

### BRIEF DESCRIPTION OF THE DRAWINGS

These and/or other aspects will become apparent and more readily appreciated from the following description of the embodiments, taken in conjunction with the accompanying drawings in which:

FIGS. 1 through 13 are diagrams for explaining a method of manufacturing a liquid crystal display apparatus according to an embodiment of the present invention. For example:

FIG. 1 is a plan view of a substrate 101 for a liquid crystal display apparatus;

FIGS. 2A-2C are cross-sectional views of various examples of a base structure taken along the line II-II of FIG. 1;

FIG. 3 is a plan view of a substrate having sacrificial patterns formed thereon;

FIG. 4 is a cross-sectional view of the substrate taken along the line IVA-IVB of FIG. 3;

FIG. 5 is the cross-sectional view of the substrate having a common electrode and a passivation layer formed thereon;

FIG. 6 is a plan view of a substrate having loop portions formed thereon;

FIGS. 7-13 are cross-sectional views taken along the line VIIA-VIIB of FIG. 6, illustrating various acts in the manufacturing of a liquid crystal display apparatus according to an embodiment of the present invention.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. It will be understood that although the terms “first”, “second”, etc. may be used herein to describe various components, these components should not be limited by these terms. These terms are only used to distinguish one component from another. Expressions such as “at least one of,” when preceding a list of elements, modify the entire list of elements and do not modify the individual elements of the list. Further, the use of “may” when describing embodiments of the present invention refers to “one or more embodiments of the present invention.”

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of components in the drawings may be exaggerated for convenience of explanation. In other words, since sizes and thicknesses of components in the drawings are arbitrarily illustrated for convenience of explanation, the following embodiments are not limited thereto.

In the following examples, the x-axis, y-axis and z-axis are not limited to three axes of the rectangular coordinate system, and may be interpreted in a broader sense. For example, the x-axis, y-axis, and z-axis may be perpendicular to one another; or may represent different directions that are not perpendicular to one another.

When a certain embodiment may be implemented differently, a specific process order may be performed differently from the described order. For example, two consecutively described processes may be performed substantially at the same time, or performed in an order opposite to the described order.

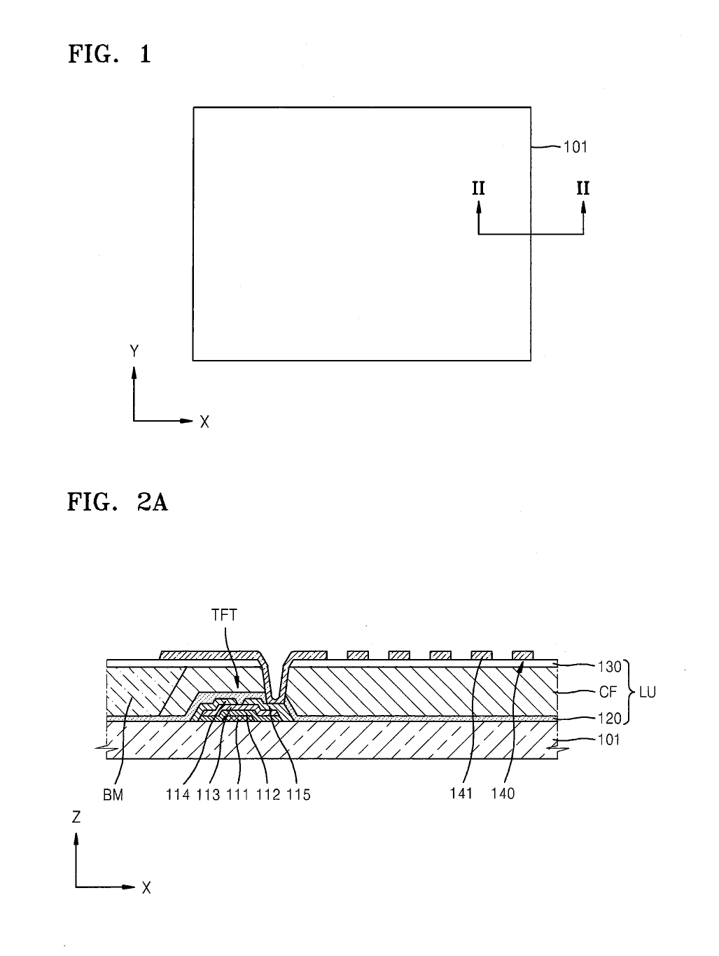

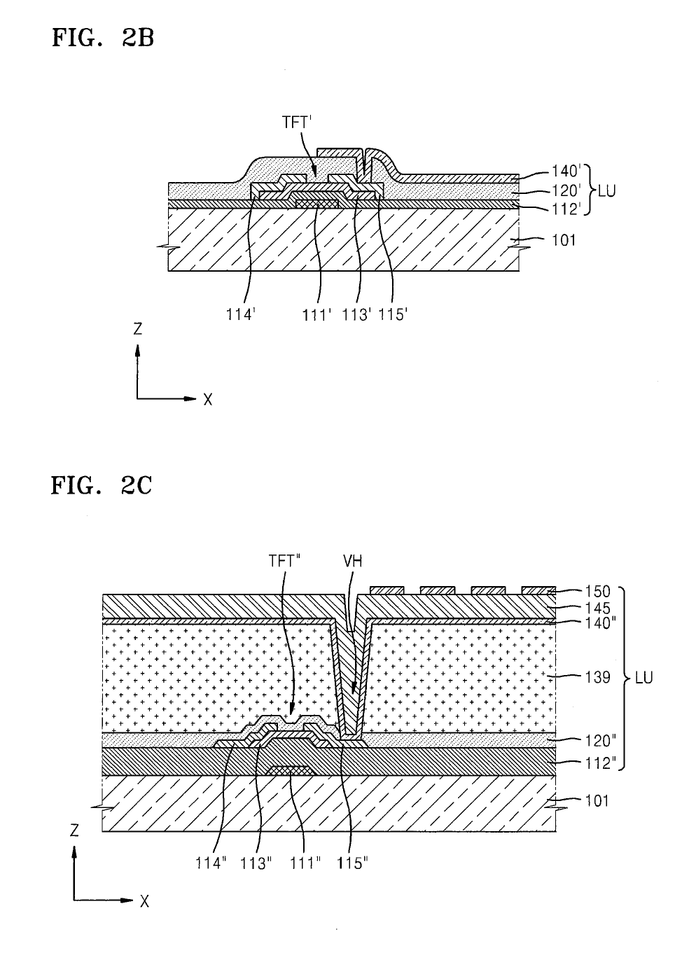

FIGS. 1 through 13 are diagrams for explaining a method of manufacturing a liquid crystal display apparatus according to an embodiment of the present invention.

Hereinafter, the present invention will be described in more detail by explaining example embodiments of the invention with reference to the attached drawings. Referring to FIG. 1, a substrate 101 is prepared.

The substrate 101 may be formed of various suitable materials. The substrate 101 may be formed of a glass material. For example, the substrate 101 may be formed of a glass material through which light may transmit. According to an embodiment, the substrate 101 may be formed of a flexible material. For example, the substrate 101 may be formed of a plastic material. In this regard, the plastic material of the substrate 101 may be at least one selected from one or more of various suitable organic substances.

According to another embodiment, the substrate 101 may be formed of a metal thin film.

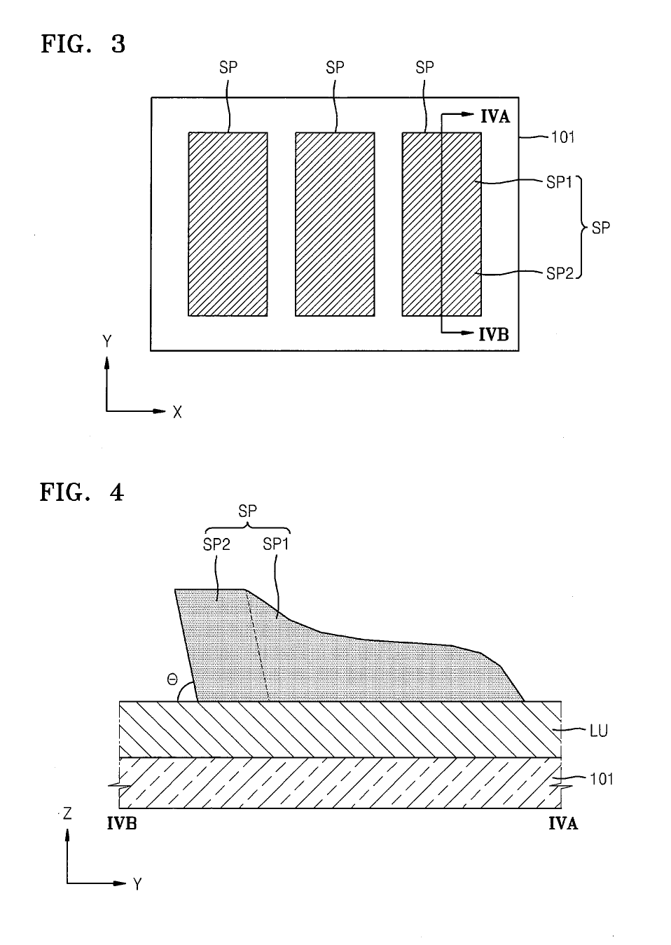

Various suitable base structures LU may be formed on the substrate 101 (see FIGS. 2A-2C). In other words, various suitable kinds of base structures LU may be formed between the substrate 101 and a liquid crystal layer (that will be described later). The base structure LU may include members necessary for performing various suitable functions, for example, one or more wirings to form an electric field to drive the liquid crystal layer or necessary members to implement various colors.

FIGS. 2A through 2C are cross-sectional views of the base structure LU that may be formed between the substrate 101 and a space where a liquid crystal layer (that will be described later) is to be disposed according to some embodiments. More particularly, FIGS. 2A through 2C are cross-sectional views of various examples of the base structure LU taken along the line II-II of FIG. 1.

An embodiment of the base structure LU will be described with reference to FIG. 2A.

The base structure LU provided on the substrate 101 includes a thin film transistor TFT, a color filter CF, a black matrix BM, and a pixel electrode 140.

The thin film transistor TFT includes a gate electrode 111, an active layer 113, a source electrode 114, and a drain electrode 115.

First, a gate electrode 111 that is formed of a conductive material (for example, a metallic material) and has a set or predetermined pattern is formed on the substrate 101. The gate electrode 111 may be coupled (e.g., connected) with a scan line that applies a scan signal.

A gate insulating layer 112 is formed on the gate electrode 111, by using (utilizing) a suitable insulation material. The active layer 113 is formed in a set or predetermined pattern on the gate insulating layer 112. The active layer 113 may include various suitable semiconducting materials, such as silicon. The active layer 113 may include an oxide semiconducting material or other various suitable materials.

The gate electrode 111 and the active layer 113 are electrically insulated from each other through the gate insulating layer 112.

The source electrode 114 and the drain electrode 115 are formed on the active layer 113. The source electrode 114 or the drain electrode 115 may be coupled with a data line that applies a data signal.

Although not illustrated, an ohmic contact layer may be further formed between the active layer 113 and the source electrode 114, and between the active layer 113 and the drain electrode 115.

In FIG. 2A, a bottom gate thin film transistor TFT is illustrated, but the present embodiment is not limited thereto. In other words, the base structure LU may include a top gate thin film transistor, or various suitable structures.

A first passivation layer 120 is formed to cover the thin film transistor TFT. The first passivation layer 120 is formed such that a set or predetermined region of the source electrode 114 or the drain electrode 115, e.g., an upper region of the drain electrode 115 of FIG. 2A, may be exposed. The pixel electrode 140 is formed in a set or predetermined pattern to be electrically coupled (e.g., electrically connected) with the exposed region of the drain electrode 115. In this regard, when the pixel electrode 140 is formed, a branch portion 141 may be formed by selectively forming a cutting pattern (e.g., a pattern may be formed on the pixel electrode 140 to have a branch portion 141).

Meanwhile, the color filter CF and the black matrix BM may be formed on the upper surface of the passivation layer 120 earlier than (prior to) the formation of the pixel electrode 140. A liquid crystal display panel displays images of various colors after finally being manufactured into the liquid crystal display panel using (utilizing) the color filter CF.

The black matrix BM reduces or prevents color mixing and interference of visible rays that are implemented (or processed) through the color filter CF.

The pixel electrode 140 may be electrically coupled with the drain electrode 115 by forming a second passivation layer 130 on upper surfaces of the black matrix BM and the color filter CF, and forming the pixel electrode 140 on an upper surface of the second passivation layer 130.

Additionally, an alignment layer may be further formed on the pixel electrode 140. An alignment layer may be further formed on a top inner surface of a cavity where the liquid crystal layer is to be placed during a process that will be described later.

Another embodiment of the base structure LU will be described with reference to FIG. 2B.

The base structure LU provided on the substrate 101 includes a thin film transistor TFT′ and a pixel electrode 140′.

The thin film transistor TFT′ includes a gate electrode 111′, an active layer 113′, a source electrode 114′, and a drain electrode 115′.

The gate electrode 111′ is formed on the substrate 101. A gate insulating layer 112′ is formed on the gate electrode 111′. The active layer 113′ is formed on the gate insulating layer 112′ in a set or predetermined pattern. The source electrode 114′ and the drain electrode 115′ are formed on the active layer 113′.

A structure of the thin film transistor TFT′ illustrated in FIG. 2B may be the same as, or similar to, or may be different from the structure of the thin film transistor TFT illustrated in FIG. 2A.

A first passivation layer 120′ is formed to cover the thin film transistor TFT′. The first passivation layer 120′ is formed such that a set or predetermined region of the source electrode 114′ or the drain electrode 115′, e.g., an upper surface of the drain electrode 115′ of FIG. 2B may be exposed. The pixel electrode 140′ is formed in a set or predetermined pattern to be electrically coupled with the exposed region of the drain electrode 115′.

Although not shown, after forming a liquid crystal layer (that will be described later), a color filter and a black matrix may be formed on an upper surface of the liquid crystal layer. However, the present embodiment does not limit specific locations of the color filter and the black matrix. According to an embodiment, the black matrix and the color filter may be formed in a lower portion of the liquid crystal layer, i.e., on the base structure LU.

Another embodiment of the base structure LU will be described with reference to FIG. 2C.

The base structure LU provided on the substrate 101 includes a thin film transistor TFT″ and a pixel electrode 140″.

The thin film transistor TFT″ includes a gate electrode 111″, an active layer 113″, a source electrode 114″, and a drain electrode 115″.

Although not shown, a buffer layer may be formed on the substrate 101 and the thin film transistor TFT″. The buffer layer reduces or prevents impure elements from penetrating through the substrate 101, and provides a planar surface to the substrate 101. The buffer layer may be formed of various suitable materials that may perform such functions. The buffer layer may be included in the above-described structures of FIGS. 2A and 2B.

The gate electrode 111″ is formed on the substrate 101. A gate insulating layer 112″ is formed on the gate electrode 111″. The active layer 113″ is formed on the gate insulating layer 112″. The active layer 113″ and the gate electrode 111″ are insulated from each other by the gate insulating layer 112″.

The source electrode 114″ and the drain electrode 115″ are formed on the active layer 113″.

A first passivation layer 120″ is formed on the source electrode 114″ and the drain electrode 115″. A planarization layer 139 is formed on the first passivation layer 120″. The planarization layer 139 may have a set or predetermined thickness in order to provide a planar (e.g., flat) surface to an upper portion thereof, and the lower portion of which is curved by shapes of other members underneath. In addition, the planarization layer 139 may include an organic material.

A pixel electrode 140″ is formed on the planarization layer 139. The pixel electrode 140″ is coupled to the drain electrode 115″ through a via hole VH. In other words, a set or predetermined region of the drain electrode 115″ is exposed by removing a set or predetermined region of the first passivation layer 120″ and the planarization layer 139 (which are insulating films interposed between the drain electrode 115″ and the pixel electrode 140″) to form the via hole VH. The pixel electrode 140 is formed to contact with the drain electrode 115″ that is exposed through the via hole VH.

An intermediate insulating layer 145 is formed on the pixel electrode 140″. The intermediate insulating layer 145 may be formed of various suitable insulation materials, such as oxide, nitride, or others.

A common electrode 150 is formed on the intermediate insulating layer 145. The common electrode 150 may be formed to have a plurality of slit shapes corresponding to the pixel electrode 140″. An image is formed by controlling the arrangement of a liquid crystal layer (that will be described later) through an electric field formed between the pixel electrode 140″ and the common electrode 150.

Although not shown, a back light unit that provides light may be further disposed adjacent to the substrate 101. The back light unit that provides light may be further disposed adjacent to the substrate 101 in FIGS. 2A and 2B.

A structure of the thin film transistor TFT″ illustrated in FIG. 2C may be the same as, or similar to, or may be different from the structures of the thin film transistors TFT and TFT′ of FIGS. 2A and 2B, respectively.

Although not shown, after forming the liquid crystal layer (that will be described later), a color filter and a black matrix may be formed on an upper portion of the liquid crystal layer. However, the present embodiment does not limit specific locations of the color filter and the black matrix. According to an embodiment, the black matrix and the color filter may be formed in a lower portion of the liquid crystal layer, i.e. on the base structure LU.

A process after forming the base structure LU on the substrate 101 as shown in FIGS. 2A through 2C will be described.

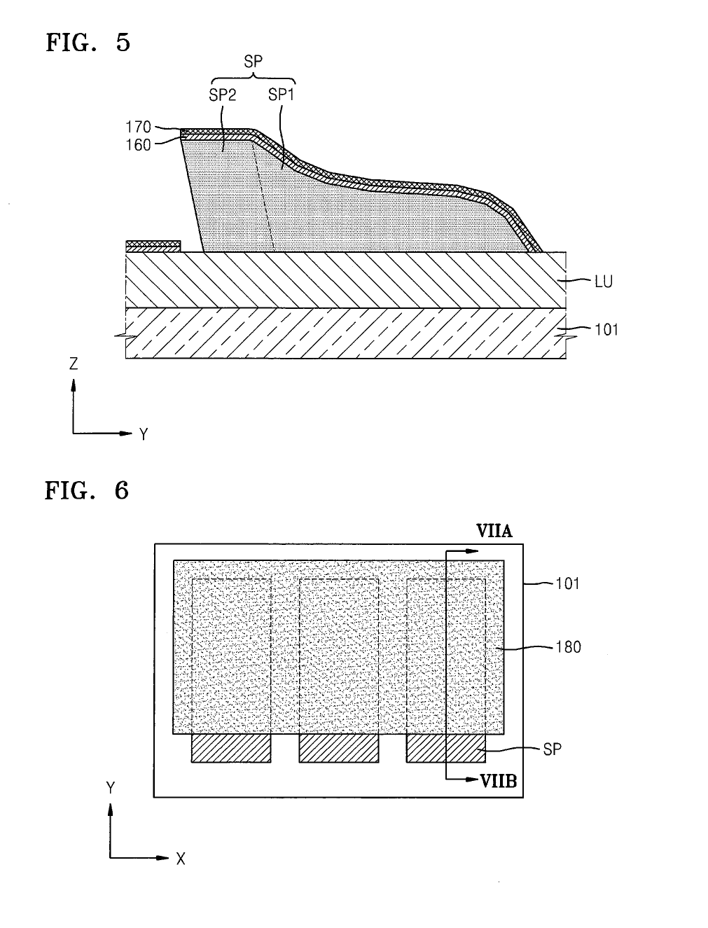

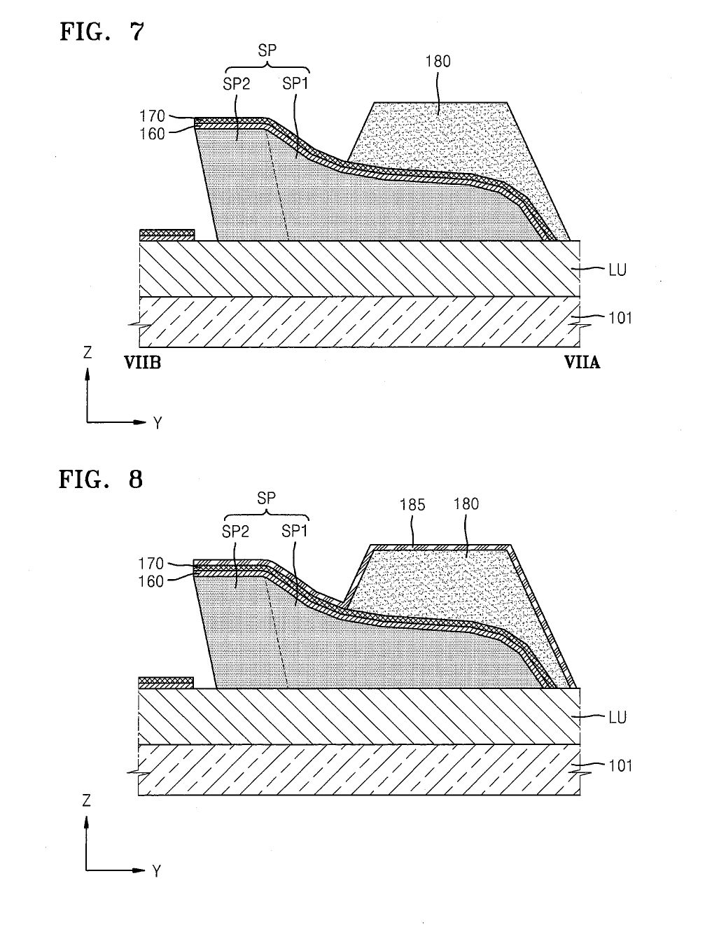

Referring to FIGS. 3 and 4, a sacrificial pattern SP is formed on the base structure LU of the substrate 101. The base structure LU may be, for example, the base structure LU illustrated in FIG. 2A.

FIG. 4 illustrates a cross-sectional view taken along the line IVA-IVB of FIG. 3. The sacrificial pattern SP is a region where a liquid crystal layer (that will be described later) may be formed. The sacrificial pattern SP is formed to correspond to the color filter of the base structure LU. The sacrificial pattern SP, corresponding to a color filter already formed or a color filter which is to be formed in a subsequent process, may also be formed in the base structure LU illustrated in FIGS. 2B and 2C.

The sacrificial pattern SP is formed of a photoresist material, and, for example, a negative photoresist material (or a negative-type photoresist material).

The sacrificial pattern SP includes a first region SP1 and a second region SP2. In other words, the first region SP1 and the second region SP2 are sequentially arranged in a width direction of the sacrificial layer SP (e.g., in a y-axis direction of FIGS. 3 and 4). A side surface of the second region SP2 acts as a path for performing a strip process in a process that will be described later. In other words, during the process that will be described later, the second region SP2 acts as a path for a strip solution.

A side surface of the first region SP1 is formed to have a gentle inclination. The side surface of the first region SP1 (facing away from the second region SP2) makes an obtuse angle with the substrate 101, and thus liquid crystals are easily injected and uniformly distributed when the liquid crystal layer (that will be described later) is formed.

The second region SP2 is connected with the first region SP1 and is formed to have a greater height than that of the first region SP1. The side surface of the second region SP2 makes a set or predetermined angle A, which is an acute angle, with the substrate 101.

A structure of the sacrificial layer SP having the first region SP1 and the second region SP2 may be formed through a photolithography process by using (utilizing) the negative-type photoresist material.

In more detail, after coating the negative photoresist material, the first region SP1 and the second region SP2 may be formed through a one-time (e.g., a single) patterning process by using (utilizing) a half-tone mask. In the half-tone mask, a region corresponding to the second region SP2 may be formed as an opening through which light wholly (or completely) transmits, and a region corresponding to the first region SP1 may be formed as a semi-transmission portion through which light partially transmits.

Thus, the side surface of the first region SP1 is formed to have the gentle inclination; and the side surface of the second region SP2 is formed in a reverse taper shape, which makes the acute angle θ with the substrate 101.

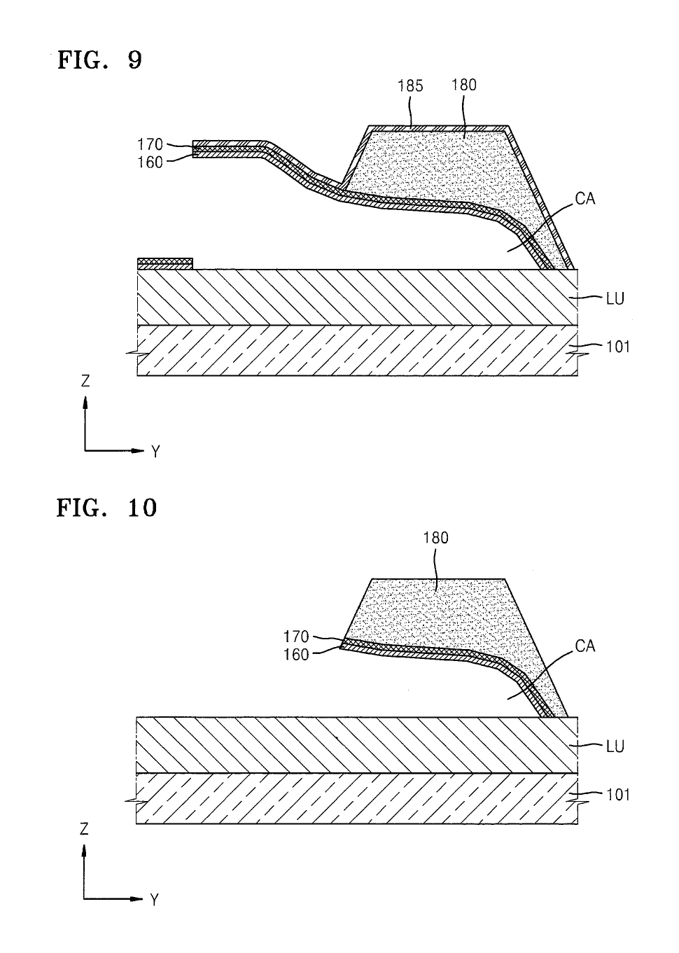

Then, referring to FIG. 5, a common electrode 160 and a third passivation layer 170 are formed. In this regard, the common electrode 160 and the third passivation layer 170 are formed entirely on the substrate 101 without any patterning. In other words, the common electrode 160 and the third passivation layer 170 are also formed on an upper surface of the sacrificial pattern SP. However, since the side surface of a second region SP2 has the reverse taper shape, the common electrode 160 and the third passivation layer 170 are not formed on at least one side surface of the second region SP2, especially on the side surface of the second region SP2 that is not connected to the first region SP1 and is far away (e.g., facing away) from the first region SP1. For example, since a thickness of the second region SP2 is greater than that of the first region SP1, the common electrode 160 and the third passivation layer 170 are not formed on the side surface of the second region SP2.

In the foregoing embodiment, when the common electrode 150 is already formed on the base structure LU of FIG. 2, the common electrode 160 of FIG. 5 may not be formed again.

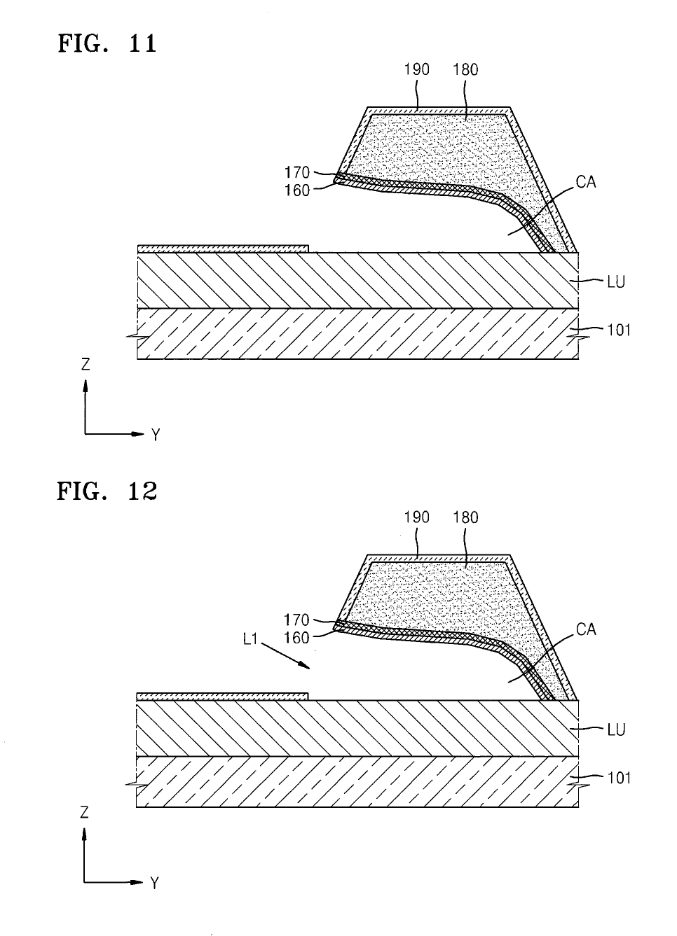

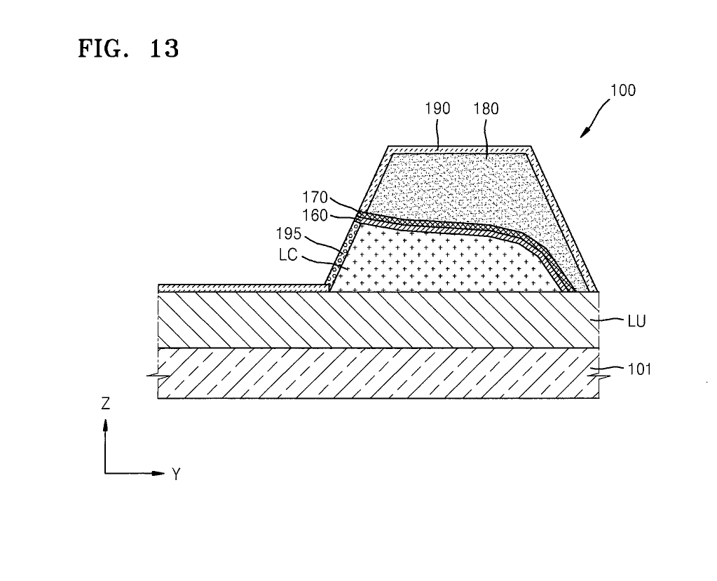

Referring to FIGS. 6 and 7, a loop portion 180 is formed. FIG. 7 is a cross-sectional view taken along the line VIIA-VIIB of FIG. 6.

The loop portion 180 is formed on a top portion and a side surface of the sacrificial pattern SP. The loop portion 180 is formed to cover a side surface of the first region SP1 facing the second region SP2. For example, the loop portion 180 is formed not to cover a region of the surface of the second region SP2 that is not covered by the common electrode 160 and the third passivation layer 170, i.e., a side surface of the second region SP2 which is far away from the first region SP1.

The loop portion 180 may be formed of an organic film. The loop portion 180 may be formed of a polymer, for example, polyethylene terephthalate (PET), polyimide, polycarbonate, epoxy, polyethylene (PE), and/or polyacrylate. For example, the loop portion 180 may include a polymerized material from a monomer composition including diacrylate-based monomer and triacrylate-based monomer. The monomer composition may further include monoacrylate-based monomer. Also, the monomer composition may further include a suitable photoinitiator such as trimethyl benzoyl diphenyl phosphine oxide (TPO), but embodiments of the present invention are not limited thereto.

In the present embodiment, a plurality of sacrificial patterns SP may be formed as illustrated in FIG. 3. According to an example embodiment, the plurality of sacrificial patterns SP may have shapes corresponding to a plurality of pixels.

The loop portions 180 are also disposed between the plurality of sacrificial patterns SP. In other words, when the plurality of sacrificial patterns SP are removed in a subsequent process, a plurality of independent cavities may be formed.

Referring to FIG. 8, an intermediate protective layer 185 is formed. In this regard, the intermediate protective layer 185 is formed entirely on the substrate 101 without any patterning. In other words, the intermediate protective layer 185 is also formed on upper surfaces of the loop portion 180, the common electrode 160, and the third passivation layer 170. However, since a side surface of a second region SP2 has a reverse taper shape, the intermediate protective layer 185 is not formed on at least one side surface of the second region SP2, especially on the side surface of the second region SP2 which is not connected to the first region SP1 and that is far away (facing away) from the first region SP1. For example, since a height of the second region SP2 is greater than that of the first region SP1, the intermediate protective layer 185 is not formed on the side surface of the second region SP2.

The intermediate protective layer 185 is formed by using (utilizing) an insulating material, such as an inorganic material. For example, the intermediate protective layer 185 may contain silicon nitride.

The intermediate protective layer 185 reduces or prevents the loop portion 180 from being damaged in a strip process (that will be described later). When the third passivation layer 170 and the common electrode 160 are dry etched or wet etched, the intermediate protective layer 185 reduces or prevents the loop portion 180 from being undesirably etched.

Referring to FIG. 9, the sacrificial pattern SP is wholly removed by performing a strip process. The strip process may utilize various suitable solutions that react to the negative photoresist material of the sacrificial pattern SP. In this regard, since a side surface of the second region SP2 is exposed, the strip solution readily reacts to the second region SP2 and the first region SP1 sequentially, and thus the sacrificial pattern SP is easily removed.

If the sacrificial pattern SP is removed, a cavity CA, which is a set or predetermined space corresponding to the sacrificial pattern SP, is formed in a lower portion of the loop portion 180.

Referring to FIG. 10, the intermediate protective layer 185 is removed. Then, regions of the third passivation layer 170 and the common electrode 160 that do not correspond to the loop portion 180, i.e. do not correspond to the cavity CA in the loop portion 180 are removed. Such a process may be performed by appropriately combining dry etching and wet etching.

Referring to FIG. 11, a cover layer 190 is formed. In this regard, the cover layer 190 is formed on the overall (the whole surface) of the substrate 101 without any patterning. In other words, the cover layer 190 is formed on the loop portion 180 and on a region on the substrate 101 that is adjacent to the loop portion 180, for example, a region of the base structure that does not overlap with the loop portion 180. However, the cover layer 190 is not formed inside the loop portion 180, i.e., not formed in a region of the cavity CA.

Referring to FIG. 12, liquid crystal is prepared to be injected toward the cavity CA of the loop portion 180. In other words, liquid crystal is prepared to be injected in a direction of an arrow L1. Then, after a liquid crystal layer LC is formed by injecting liquid crystal into the cavity CA as illustrated in FIG. 13, the crystal layer LC is blocked from leaking from the cavity CA by blocking the cavity CA with a blocking member 195. The blocking member 195 may be formed by using (utilizing) various suitable insulating materials, and may be formed of the same material as that of the loop portion 180 or the cover layer 190.

Thus, a liquid crystal display panel 100 is finally completed.

A method of manufacturing the liquid crystal display panel 100 of the present embodiment sequentially conducts the following acts: forming the sacrificial pattern SP, forming the loop portion 180, removing the sacrificial pattern SP, forming the cavity CA corresponding to the sacrificial pattern SP, injecting liquid crystal into the cavity CA, forming the liquid crystal layer LC, and forming the blocking member 195, thereby facilitating a process of forming the liquid crystal layer LC.

For example, according to the present embodiment, since the sacrificial pattern SP includes a negative photoresist material, when the sacrificial pattern SP is patterned by using (utilizing) photolithography including light exposure, the sacrificial pattern SP makes the acute angle 8 with the substrate 101. Accordingly, even though the intermediate protective layer 185 is formed without a subsequent patterning process, for example, a patterning process which needs a mask, the intermediate protective layer 185 may not cover a side surface of the sacrificial pattern SP.

As a result, the side surface of the sacrificial pattern SP is exposed, a strip solution readily permeates into the exposed side surface of the sacrificial pattern SP during a strip process, and thus the sacrificial pattern SP is easily removed. Accordingly, the cavity CA is readily formed to have a desired shape in the loop portion 180, and the liquid crystal layer LC corresponding to the cavity CA is easily formed.

In the present embodiment, the sacrificial pattern SP includes a negative photoresist material. A side surface of the sacrificial pattern SP (that forms a gentle and obtuse angle with the substrate) is formed in the opposite side (i.e., the first region SP1) of a side surface of the sacrificial pattern SP into which liquid crystal is injected through photolithography by using (utilizing) a half-tone mask. Thus, in a subsequent process, the liquid crystal layer LC may be easily formed in a region of the cavity CA corresponding to a side surface of the first region SP1, and liquid crystal molecules may be uniformly distributed in the liquid crystal layer LC.

The liquid crystal display panel 100 manufactured by using (utilizing) the method of the present embodiment has a structure in which the liquid crystal layer LC is disposed in (i.e., inside) the cavity CA, and thus a thickness and weight of the liquid crystal display panel 100 may be reduced.

The loop portion 180 is formed of an organic material so that the liquid crystal display panel 100 is provided with flexibility, thereby increasing user convenience of the liquid crystal display panel 100.

As described above, according to the one or more of the above embodiments of the present invention, a liquid crystal display panel may easily improve user convenience, and a method of manufacturing the liquid crystal display panel may easily improve the manufacturing process.

It should be understood that the example embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims, and equivalents thereof.

What is claimed is:

1. A method of manufacturing a liquid crystal display panel, the method comprising:
preparing a substrate;
forming a sacrificial pattern comprising a negative photoresist material on the substrate;
forming a loop portion to cover top and side surfaces of the sacrificial pattern and to expose one side surface of the sacrificial pattern;
forming a cavity defined as a set region in the loop portion by performing a strip process on the exposed side surface of the sacrificial pattern utilizing a strip solution and removing the sacrificial pattern;
forming a liquid crystal layer by injecting liquid crystal in the cavity; and
forming a blocking member to cover an opening of the cavity into which the liquid crystal is injected.

2. The method of claim 1, wherein the sacrificial pattern comprises a first region and a second region sequentially arranged in a width direction of the sacrificial pattern, and
wherein a side surface of the first region makes an obtuse angle with the substrate, and a side surface of the second region makes an acute angle with the substrate.

3. The method of claim 2, wherein the forming of the sacrificial pattern comprises performing photolithography utilizing a half-tone mask, and
wherein a region of the half-tone mask corresponding to the first region transmits a smaller amount of light than a region of the half-tone mask corresponding to the second region.

4. The method of claim 2, wherein the side surface of the sacrificial pattern exposed in the forming of the loop portion is formed in the second region.

5. The method of claim 2, wherein the forming of the sacrificial pattern comprises forming the second region to have a greater thickness than the first region.

6. The method of claim 2, wherein the cavity corresponds to the first region.

7. The method of claim 1, wherein the loop portion comprises an organic material.

8. The method of claim 1, further comprising, before the forming of the cavity by performing the strip process and after the forming of the loop portion, forming an intermediate protective layer on the loop portion,
wherein the intermediate protective layer is formed without a patterning process and does not cover the exposed side surface of the sacrificial pattern that is not covered by the loop portion.

9. The method of claim 8, further comprising removing the intermediate protective layer after the forming of the cavity.

10. The method of claim 1, further comprising, after the forming of the cavity and before the forming of the liquid crystal layer, forming a cover layer on the loop portion.

11. The method of claim 1, further comprising, after the forming of the sacrificial pattern and before the forming of the loop portion, forming a common electrode and a passivation layer on the sacrificial pattern,
wherein the common electrode and the passivation layer are formed not to cover the exposed side surface of the sacrificial pattern that is not covered by the loop portion.

12. The method of claim 11, further comprising, after the forming of the cavity and before the forming of the liquid crystal layer, removing regions of the passivation layer and the common electrode not corresponding to the cavity.

13. The method of claim 1, further comprising, after the preparing of the substrate and before the forming of the sacrificial pattern, forming a base structure comprising one or more wirings between the substrate and the sacrificial pattern.

14. The method of claim 13, wherein the base structure comprises:
at least one thin film transistor comprising an active layer, a gate electrode, a source electrode, and a drain electrode; and
a pixel electrode electrically coupled with the at least one thin film transistor.

15. The method of claim 14, wherein the liquid crystal display panel comprises a color filter and a black matrix between the at least one thin film transistor and the pixel electrode.

16. The method of claim 14, wherein the base structure comprises:
a common electrode on an upper portion of the pixel electrode; and
an intermediate insulating layer between the pixel electrode and the common electrode.

17. The method of claim 1, wherein the forming of the sacrificial pattern comprises forming a plurality of sacrificial patterns spaced apart from each other, and
wherein the loop portion is between the plurality of sacrificial patterns.

18. The method of claim 17, wherein the forming of the cavity comprises forming a plurality of cavities spaced apart from each other and corresponding to the plurality of sacrificial patterns.

19. A liquid crystal display panel manufactured by utilizing the method of claim 1.

20. A system of manufacturing a liquid crystal display panel, the system comprising:
means for preparing a substrate;
means for forming a sacrificial pattern comprising a negative photoresist material on the substrate;
means for forming a loop portion to cover top and side surfaces of the sacrificial pattern and to expose one side surface of the sacrificial pattern;
means for forming a cavity defined as a set region in the loop portion by performing a strip process on the exposed side surface of the sacrificial pattern utilizing a strip solution and removing the sacrificial pattern;
means for forming a liquid crystal layer by injecting liquid crystal in the cavity; and
means for forming a blocking member to cover an opening of the cavity into which the liquid crystal is injected.
